(19) United States
(12) Patent Application Publication
(10) Pub. No.: US 2022/0059305 A1
(43) Pub. Date: Feb. 24, 2022

(54) RELAY DEVICE

(71) Applicant: TOYOTA JIDOSHA KABUSHIKI KAISHA, Toyota-shi (JP)

(72) Inventor: Mitsugu NONOMURA, Toyota-shi (JP)

(73) Assignee: TOYOTA JIDOSHA KABUSHIKI KAISHA, Toyota-shi (JP)

(21) Appl. No.: 17/384,881

(22) Filed: Jul. 26, 2021

(30) Foreign Application Priority Data
Aug. 20, 2020 (JP) 2020-139232

(51) Int. Cl. H01H 45/14; H01H 45/04

(52) U.S. Cl. CPC H01H 45/14; H01H 45/04

(57) ABSTRACT

A relay device includes a positive terminal, a negative terminal spaced from the positive terminal, and a movable terminal that moves between a connection position and a distant position, the connection position being a position at which the movable terminal connects the positive terminal to the negative terminal, the distant position being a position at which the movable terminal is distant from the positive terminal and the negative terminal. The movable terminal includes a first contact portion connected to the positive terminal, a first portion extending away from the first contact portion, a second contact portion connected to the negative terminal, a second portion extending away from the second contact portion, and a connecting portion connecting the first portion to the second portion. The first portion and the second portion are disposed to be opposed to each other.

This nonprovisional application is based on Japanese Patent Application No. 2020-139232 filed on Aug. 20, 2020 with the Japan Patent Office, the entire contents of which are hereby incorporated by reference.

### BACKGROUND

### Field

The present disclosure relates to a relay device.

### Description of the Background Art

A relay device has conventionally been known that is mounted in a hybrid system or the like. For example, a relay device disclosed in Japanese Patent Laying-Open No. 2017-175675 includes a positive fixed terminal, a negative fixed terminal, and a moving iron core.

The moving iron core is provided to move between a position at which the moving iron core is in contact with the positive fixed terminal and the negative fixed terminal and a position at which the moving iron core is distant from the positive fixed terminal and the negative fixed terminal.

As the moving iron core contacts the positive fixed terminal and the negative fixed terminal, the positive fixed terminal and the negative fixed terminal are electrically connected to each other. Then, a current flows through the positive fixed terminal, the moving iron core, and the negative fixed terminal.

The relay device is connected between a battery and a direct-current (DC)-DC converter. The DCDC converter is connected to an inverter, and the inverter is connected to a motor.

The battery supplies DC power to the DCDC converter through the relay device. The DCDC converter steps up the DC power supplied from the battery and supplies the DC power to the inverter.

The inverter converts the DC power supplied from the DCDC converter into alternating-current (AC) power and supplies the AC power to the motor.

The inverter includes a plurality of switching elements and may generate a high-frequency ripple current in the inverter as the plurality of switching elements turn on/off.

Since the relay device is connected to the inverter through the DCDC converter, the ripple current generated in the inverter is transferred to the relay device. When the ripple current flows through the relay device, the ripple current also flows through the moving iron core.

When the high-frequency ripple current flows through the moving iron core, a high-frequency electromagnetic field is radiated from the moving iron core. This exposes the moving iron core and metallic members therearound to the high-frequency electromagnetic field. When the moving iron core and the metallic members therearound are exposed to the high-frequency electromagnetic field, the moving iron core and magnetic metals vibrate, causing abnormal noise from the moving iron core and the magnetic metals.

### SUMMARY

The present disclosure has been made in view of the above problem, and has an object to provide a relay device that restricts the occurrence of a high-frequency electromagnetic field.

A relay device according to the present disclosure includes a positive terminal, a negative terminal spaced from the positive terminal, and a movable terminal that moves between a connection position and a distant position, the connection position being a position at which the movable terminal connects the positive terminal to the negative terminal, the distant position being a position at which the movable terminal is distant from the positive terminal and the negative terminal. The movable terminal includes a first contact portion connected to the positive terminal, a first portion extending away from the first contact portion, a second contact portion connected to the negative terminal, a second portion extending away from the second contact portion, and a connecting portion connecting the first portion to the second portion. The first portion and the second portion are disposed to be opposed to each other.

In the relay device, even when a ripple current flows through the first portion and the second portion, the ripple current flows through the first portion and the second portion in the opposite directions. The first portion and the second portion are disposed to be opposed to each other. Thus, an electromagnetic field formed by the ripple current flowing through the first portion and an electromagnetic field formed by the ripple current flowing through the second portion attenuate each other. This can restrict the radiation of the electromagnetic field from the relay device.

The movable terminal includes a first flange in which the first contact portion is formed and which is formed to project from a first connecting portion at which the first flange is connected with the first portion, and a second flange in which the second contact portion is formed and which is formed to project from a second connecting portion at which the second flange is connected with the second portion. A length by which the first flange projects from the first connecting portion is smaller than each of a length of the first portion and a length of the second portion.

In the relay device, the first flange and the second flange each have a short length. Thus, even when an electromagnetic field is formed by a ripple current flowing through the first flange and the second flange, the radiation of a high-intensity electromagnetic field is restricted.

The positive terminal and the negative terminal are disposed to be opposed to each other. In the relay device, even when a ripple current flows through the positive terminal and the negative terminal, an electromagnetic field formed in the positive terminal and an electromagnetic field formed in the negative terminal attenuate each other.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a block diagram schematically showing a drive system 3 of a vehicle.

FIG. 2 is a schematic exploded perspective view of a junction box 2.

FIG. 3 is a schematic sectional view of a relay device 10.

FIG. 4 is a schematic perspective view of a movable terminal 22, a positive terminal 20, and a negative terminal 21.

FIG. 5 is a perspective view showing a state in which movable terminal 22 is connected to positive terminal 20 and negative terminal 21.

FIG. 6 shows results obtained in various types of junction boxes 2A, 2B, 2C by examining abnormal noise that occurs from each of junction boxes 2A, 2B, 2C.

FIG. 7 is a perspective view of a movable terminal 22A and components therearound.

FIG. 8 is a perspective view of a connecting portion 58 and components therearound.

FIG. 9 schematically shows an experiment system 60 in which an inter-wire distance and an amount of radiation of an electromagnetic field are visualized.

FIG. 10 is a sectional view of experiment system 60.

FIG. 11 is a graph showing results obtained in experiment system 60 by measuring sound pressures of sounds picked up by a microphone 64 while variously changing inter-wire distance L1.

### DESCRIPTION OF THE PREFERRED EMBODIMENTS

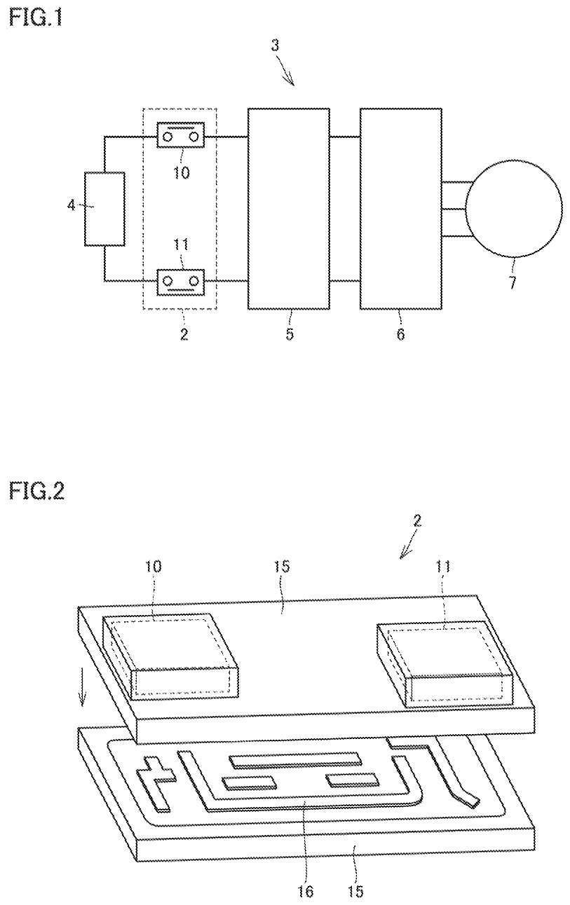

A relay device according to the present embodiment will be described with reference to FIGS. 1 to 11. The same or substantially the same components of the components shown in FIGS. 1 to 11 are denoted by the same references, and redundant description will be omitted.

FIG. 1 is a block diagram schematically showing a drive system 3 of a vehicle. Drive system 3 includes a junction box 2, a battery 4, a DCDC converter 5, an inverter 6, and a rotating electric machine 7.

Junction box 2 is electrically connected between DCDC converter 5 and battery 4. Inverter 6 is connected to DCDC converter 5, and rotating electric machine 7 is connected to inverter 6.

Battery 4 is a secondary battery, such as a lithium-ion battery. Junction box 2 is a device that switches an electrical connection between battery 4 and DCDC converter 5. Junction box 2 includes a relay device 10 and a relay device 11.

DCDC converter 5 steps up DC power supplied from battery 4 and supplies the DC power to inverter 6. Inverter 6 includes a plurality of switching elements, such as transistors, and a plurality of diodes. Inverter 6 converts the DC power supplied from DCDC converter 5 into AC power, such as three-phase AC power, and supplies the AC power to rotating electric machine 7.

Rotating electric machine 7 is, for example, a three-phase AC motor and is driven by the AC power supplied from inverter 6. Rotating electric machine 7 is mechanically connected to a driving wheel or the like.

FIG. 2 is a schematic exploded perspective view of junction box 2. Junction box 2 includes a housing case 15, a bus bar 16, and relay devices 10, 11.

Bus bar 16 is wiring connecting relay devices 10, 11 to battery 4 and connecting relay devices 10, 11 to DCDC converter 5.

Relay device 11 is configured substantially similarly to relay device 10. Thus, relay device 10 will be described in detail.

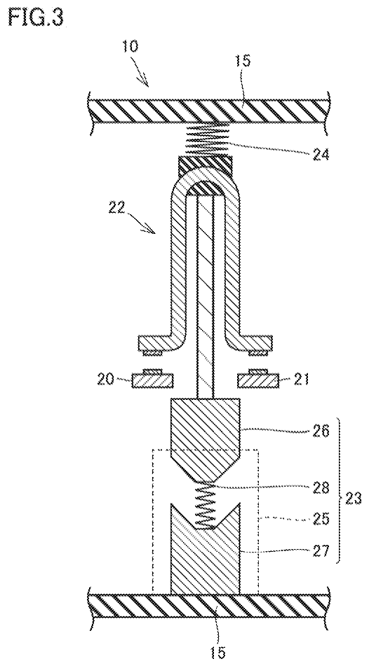

FIG. 3 is a schematic sectional view of relay device 10. Relay device 10 includes a positive terminal 20, a negative terminal 21, a movable terminal 22, a driving device 23, and a spring 24.

Positive terminal 20 and negative terminal 21 are fixed to bus bar 16 of housing case 15. Spring 24 biases movable terminal 22 toward positive terminal 20 and negative terminal 21.

Driving device 23 includes a coil 25, a moving iron core 26, a fixed iron core 27, and a spring 28. Fixed iron core 27 is fixed to housing case 15, and coil 25 is formed to surround fixed iron core 27. Moving iron core 26 is provided so as to move relative to fixed iron core 27. Moving iron core 26 has one end connected to movable terminal 22.

Spring 28 is provided between moving iron core 26 and fixed iron core 27 and biases moving iron core 26 and fixed iron core 27 so as to separate the cores from each other.

With no current flowing through coil 25, the biasing force of spring 28 separates movable terminal 22 from positive terminal 20 and negative terminal 21. As a current flows through coil 25, moving iron core 26 is attracted to fixed iron core 27 against the biasing force of spring 28, and accordingly, movable terminal 22 contacts positive terminal 20 and negative terminal 21.

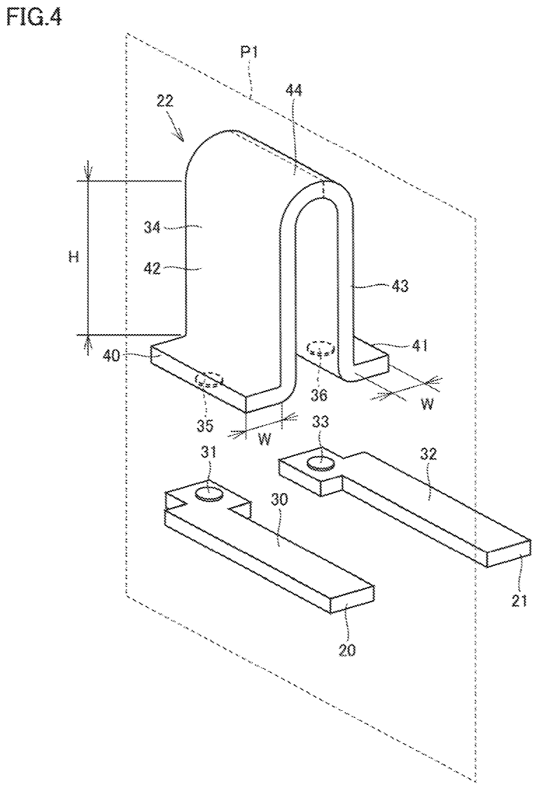

FIG. 4 is a schematic perspective view of movable terminal 22, positive terminal 20, and negative terminal 21. Positive terminal 20 includes a terminal body 30 and a contact portion 31. Negative terminal 21 includes a terminal body 32 and a contact portion 33. Positive terminal 20 and negative terminal 21 are formed symmetrically about a virtual plane P1. Positive terminal 20 and negative terminal 21 are spaced from each other. Virtual plane P1 extends vertically and is disposed to pass through between positive terminal 20 and negative terminal 21.

Movable terminal 22 includes a terminal body 34 and contact portions 35, 36. Terminal body 34 is made of, for example, a metallic material such as iron. Terminal body 34 includes flanges 40, 41, upright portions 42, 43, and a connecting portion 44.

Contact portion 35 is formed in the lower surface of flange 40. Contact portion 35 contacts contact portion 31 as movable terminal 22 contacts positive terminal 20. Flange 40 is formed to extend horizontally. Flange 40 is formed in a plate shape.

Contact portion 36 is formed in the lower surface of flange 41. Contact portion 36 contacts contact portion 33 as movable terminal 22 contacts positive terminal 20. Flange 41 is formed to extend horizontally. Flange 41 is formed in a plate shape.

Upright portion 42 is formed to rise from flange 40. Specifically, upright portion 42 is formed to rise upward from a lateral side of the outer circumferential edge of flange 40 which is opposed to flange 41. Upright portion 42 thus extends upward away from contact portion 35.

Upright portion 43 is formed to rise from flange 41. Specifically, upright portion 43 is formed to rise from a lateral side of the outer circumferential edge of flange 41 which is opposed to flange 40. Upright portion 43 thus extends upward away from contact portion 36.

Upright portion 42 and upright portion 43 are spaced from each other and are disposed to be opposed to each other. Upright portion 42 and upright portion 43 are disposed to be symmetrical about virtual plane P1.

Flange 40 is formed to extend horizontally from a lower end (first connecting portion) of upright portion 42 and extends away from flange 41. Flange 41 is formed to extend horizontally from a lower end (second connecting portion) of upright portion 43 and extends away from flange 40.

When the length by which flange 40 projects horizontally from the end of upright portion 42 is a length of projection W, flange 40 and flange 41 have the same length of projection. Length of projection W is smaller than a height H of each of upright portion 42 and upright portion 43. For example, length of projection W is greater than 0 mm and is equal to or smaller than a quarter of height H. Length of projection W may be equal to or smaller than a tenth of height H.

Connecting portion 44 is formed to connect the upper end of upright portion 42 to the upper end of upright portion 43. Connecting portion 44 is formed in a curved plane shape. Connecting portion 44 is formed to have a symmetrical shape about virtual plane P1. Relay device 11 is formed similarly to relay device 10.

Referring to FIG. 1, a high-frequency ripple current may be generated in inverter 6 during driving of drive system 3.

Since junction box 2, DCDC converter 5, and inverter 6 are electrically connected to each other, the ripple current generated in inverter 6 may reach junction box 2.

FIG. 5 is a perspective view showing a state in which movable terminal 22 is connected to positive terminal 20 and negative terminal 21. As drive system 3 is driven, a current flows with movable terminal 22 connected to positive terminal 20 and negative terminal 21.

It is assumed here that a high-frequency ripple current has flowed through movable terminal 22. A ripple current μl in FIG. 5 indicates a direction in which the ripple current flows at one moment. At this moment in FIG. 5, ripple current μl flows through flange 40, upright portion 42, connecting portion 44, upright portion 43, and flange 41 in order.

Since the ripple current is a high-frequency current, a high-frequency electromagnetic field is radiated from each part as the ripple current flows through each part.

Ripple current μl flows through upright portion 42 and upright portion 43 in the opposite directions, and upright portion 42 and upright portion 43 are formed to be symmetrical about virtual plane P1. Thus, the electromagnetic field radiated from upright portion 42 and the electromagnetic field radiated from upright portion 43 counteract each other.

Connecting portion 44 is formed to have a symmetrical shape about virtual plane P1. Also in connecting portion 44, thus, the radiation of an electromagnetic field from connecting portion 44 is restricted even when the ripple current flows through connecting portion 44.

Further, since length of projection W of each of flanges 40, 41 is small as described above, the magnitude of the electromagnetic field generated in each of flanges 40, 41 is small, and accordingly, the electromagnetic field little affects its surroundings.

In this manner, since the radiation of an electromagnetic field from movable terminal 22 is restricted, exposure of movable terminal 22 itself to the electromagnetic field is restricted as well.

As a result, movable terminal 22 causes magnetostriction less easily, thus restricting the occurrence of abnormal noise from movable terminal 22. Exposure of positive terminal 20 and negative terminal 21 to an electromagnetic field is also restricted, and positive terminal 20 and negative terminal 21 cause magnetostriction less easily, thus restricting the occurrence of abnormal noise from positive terminal 20 and negative terminal 21.

In positive terminal 20 and negative terminal 21, the direction of ripple current μl flowing through positive terminal 20 is opposite to the direction of ripple current μl flowing through negative terminal 21. Positive terminal 20 and negative terminal 21 are formed to be symmetrical about virtual plane P1 and are disposed to be opposed to each other with virtual plane P1 therebetween. Thus, the electromagnetic field radiated from positive terminal 20 and the electromagnetic field radiated from negative terminal 21 counteract each other.

In relay device 10 according to the present embodiment, the radiation of an electromagnetic field from relay device 10 is restricted even when ripple current μl flows through relay device 10, as described above.

Thus, for example, exposure of bus bar 16 to an electromagnetic field can be restricted, and the occurrence of abnormal noise from bus bar 16 can be restricted in the case where bus bar 16 is made of a magnetic metal. For example, when bus bar 16 is exposed to an electromagnetic field, magnetostriction occurs in bus bar 16 itself, causing abnormal noise. Moreover, as bus bar 16 vibrates, bus bar 16 and housing case 15 repeatedly collide with each other.

### Example 1

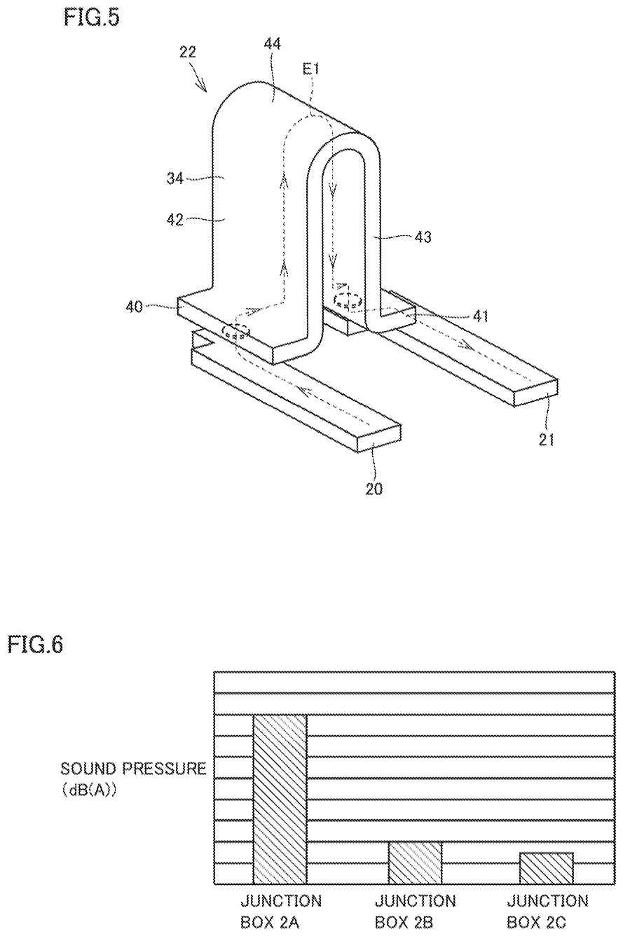

FIG. 6 shows results obtained in various types of junction boxes 2A, 2B, 2C by examining abnormal noise that occurs from junction boxes 2A, 2B, 2C. The vertical axis of FIG. 6 indicates sound pressures (dB(A)) of abnormal noise that occurs from each of junction boxes 2A, 2B, 2C. Schematic configurations of junction boxes 2A, 2B, 2C will be described.

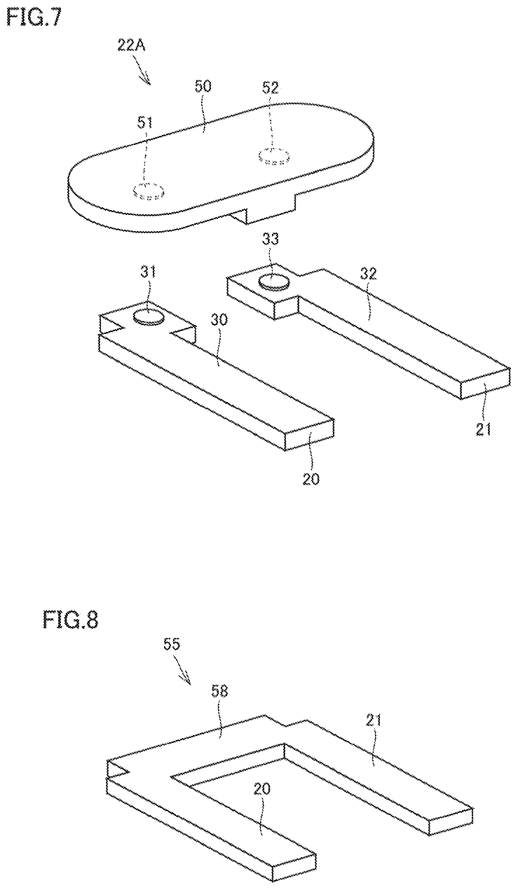

Junction box 2A includes a movable terminal 22A shown in FIG. 7 in place of movable terminal 22 of junction box 2 of the present embodiment. Note that bus bar 16 shown in FIG. 2 is not bonded to housing case 15 in junction box 2A.

Junction box 2B includes a connecting portion 58 shown in FIG. 8 in place of movable terminal 22 of junction box 2 of the present embodiment. Note that bus bar 16 shown in FIG. 2 is not bonded to housing case 15 in junction box 2B.

Junction box 2C includes connecting portion 58 shown in FIG. 8 in place of movable terminal 22 of junction box 2 of the present embodiment. Note that bus bar 16 shown in FIG. 2 is bonded to housing case 15 in junction box 2C.

Movable terminal 22A mounted in junction box 2A will now be described. FIG. 7 is a perspective view of movable terminal 22A and components therearound. Movable terminal 22A includes a plate-shaped terminal body 50 and terminal portions 51, 52. Terminal portions 51, 52 are formed in the lower surface of terminal body 50. Terminal body 50 is formed in a plate shape and is formed to extend horizontally. As movable terminal 22A contacts positive terminal 20 and negative terminal 21, positive terminal 20 and negative terminal 21 are electrically conducted with each other.

Connecting portion 58 mounted in junction box 2B will now be described. FIG. 8 is a perspective view of connecting portion 58 and components therearound. Connecting portion 58 is provided to connect positive terminal 20 to negative terminal 21 and is formed to extend linearly from an end of positive terminal 20 to an end of negative terminal 21. Connecting portion 58 is integrated with positive terminal 20 and negative terminal 21.

A case where a current is flowed through junction boxes 2A, 2B, 2C will now be described. Junction box 2A includes movable terminal 22A shown in FIG. 7. In movable terminal 22A, as ripple current μl flows, ripple current μl flows from one end side to the other end side of movable terminal 22A. Thus, as an electromagnetic field is radiated by ripple current μl flowing through movable terminal 22A, the electromagnetic field is canceled less easily.

As a result, the electromagnetic field is radiated from movable terminal 22A to its surroundings. Movable terminal 22A itself is thus exposed to the electromagnetic field, causing magnetostriction in movable terminal 22A, which results in the occurrence of abnormal noise from movable terminal 22A.

In particular, when magnetostriction occurs in movable terminal 22A, movable terminal 22A vibrates at high frequency. Movable terminal 22A and positive terminal 20 are pressed against each other by a biasing force of the spring. Accordingly, when movable terminal 22A deforms due to the magnetostriction, movable terminal 22A and positive terminal 20 repeatedly collide with each other. Similarly, movable terminal 22A and negative terminal 21 repeatedly collide with each other. This results in the occurrence of loud abnormal noise from movable terminal 22A, positive terminal 20, and negative terminal 21.

Positive terminal 20, negative terminal 21, bus bar 16, and the like are also exposed to the electromagnetic field radiated from movable terminal 22A, and when positive terminal 20, negative terminal 21, and bus bar 16 are made of a magnetic metal, magnetostriction occurs in positive terminal 20, negative terminal 21, and bus bar 16. This results in the occurrence of abnormal noise from positive terminal 20, negative terminal 21, and bus bar 16.

In junction box 2A, bus bar 16 is attached to housing case 15, and bus bar 16 is not bonded to housing case 15. Thus, when magnetostriction occurs in bus bar 16, which is made of a magnetic metal, bus bar 16 and housing case 15 repeatedly collide with each other. This collision also causes abnormal noise.

Junction box 2B will now be described. Junction box 2B includes connecting portion 58 shown in FIG. 8. Since connecting portion 58 is formed to extend linearly, an electromagnetic field is radiated from connecting portion 58 more easily when ripple current μl flows through connecting portion 58.

Herein, when an electromagnetic field is radiated from connecting portion 58, connecting portion 58, positive terminal 20, negative terminal 21, and bus bar 16 are exposed to the electromagnetic field. When connecting portion 58, positive terminal 20, negative terminal 21, and bus bar 16 are made of a magnetic metal, magnetostriction occurs in connecting portion 58, positive terminal 20, negative terminal 21, and bus bar 16. This results in the occurrence of abnormal noise from connecting portion 58, positive terminal 20, negative terminal 21, and bus bar 16.

Since connecting portion 58 is integrated with positive terminal 20 and negative terminal 21, even when magnetostriction occurs in connecting portion 58, positive terminal 20, and negative terminal 21, connecting portion 58 does not collide with positive terminal 20 or negative terminal 21.

In junction box 2B, bus bar 16 is not bonded to housing case 15. Thus, when magnetostriction occurs in bus bar 16, which is made of a magnetic metal, bus bar 16 repeatedly collides with housing case 15. This collision also causes abnormal noise.

Junction box 2C will now be described. Similarly to junction box 2B, junction box 2C also includes connecting portion 58. Thus, when connecting portion 58, positive terminal 20, negative terminal 21, and bus bar 16 are made of a magnetic metal, similarly to junction box 2B, abnormal noise occurs from connecting portion 58, positive terminal 20, negative terminal 21, and bus bar 16 as magnetostriction occurs in connecting portion 58, positive terminal 20, negative terminal 21, and bus bar 16.

At the same time, in junction box 2C, abnormal noise caused by collision of housing case 15 with bus bar 16 is restricted because bus bar 16 is bonded to housing case 15.

Referring to FIG. 6, abnormal noise that occurs from junction box 2B is much smaller than abnormal noise that occurs from junction box 2A. In junction box 2A, abnormal noise is caused by terminal body 50 colliding with positive terminal 20 and negative terminal 21. Contrastingly, in junction box 2B including connecting portion 58, abnormal noise as described above does not occur.

The abnormal noise that occurs from junction box 2C is smaller than the abnormal noise that occurs from junction box 2B. In junction box 2B, bus bar 16 is not bonded to housing case 15, and accordingly, abnormal noise occurs by bus bar 16 colliding with housing case 15. Contrastingly, in junction box 2C, bus bar 16 is bonded to housing case 15, and accordingly, the occurrence of abnormal noise as described above is restricted.

FIG. 6 shows that abnormal noise is extremely loud which is caused by a collision between the movable terminal and positive terminal 20 or a collision between the movable terminal and negative terminal 21 due to magnetostriction.

In junction box 2 according to the present embodiment, the radiation of an electromagnetic field from movable terminal 22 is restricted, as show in FIG. 5 or the like. Also when movable terminal 22, positive terminal 20, negative terminal 21, and bus bar 16 are made of a magnetic metal, thus, abnormal noise caused by magnetostriction caused in movable terminal 22, positive terminal 20, negative terminal 21, and bus bar 16 can be restricted. Moreover, the occurrence of abnormal noise is restricted which is caused by a collision between movable terminal 22 and positive terminal 20 or a collision between movable terminal 22 and negative terminal 21. Moreover, since the occurrence of magnetostriction in bus bar 16 is restricted, the occurrence of abnormal noise is also restricted which is caused by bus bar 16 colliding with housing case 15.

As described above, junction box 2 according to the present embodiment can restrict the occurrence of abnormal noise from junction box 2.

### Example 2

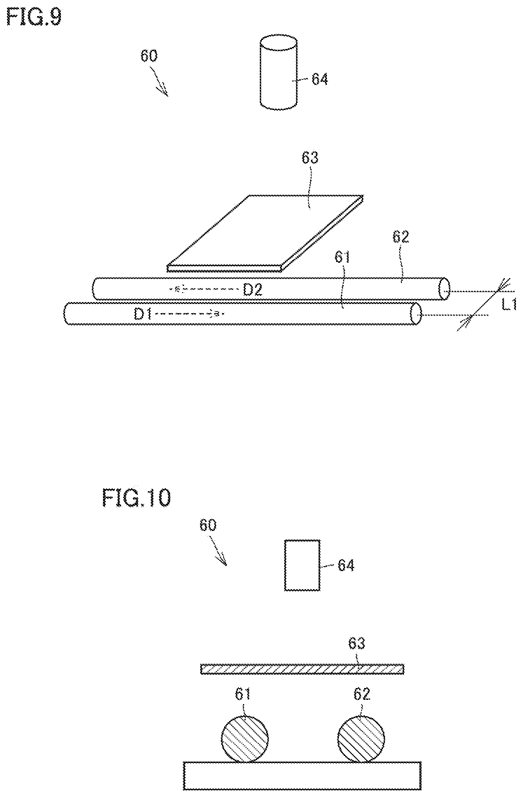

FIG. 9 schematically shows an experiment system 60 in which an inter-wire distance and an amount of radiation of an electromagnetic field are visualized. FIG. 10 is a sectional view of experiment system 60.

Experiment system 60 includes a wiring harness 61, a wiring harness 62, an iron plate (magnetic body) 63, and a microphone 64.

Wiring harness 61 and wiring harness 62 are disposed in parallel with each other. Stainless steel plate 63 is spaced from and above wiring harnesses 61, 62. Stainless steel plate 63 is positioned 10 mm above wiring harnesses 61, 62. Microphone 64 is disposed above stainless steel plate 63. Microphone 64 is disposed 400 mm above wiring harnesses 61, 62.

Wiring harnesses 61, 62 are connected to an AC source (not shown), and an AC current flows through wiring harnesses 61, 62.

The AC current flowing through wiring harness 61 and the AC current flowing through wiring harness 62 are 180° out of phase. Thus, a direction of a current D1 flowing through wiring harness 61 is opposite to a direction of current D2 flowing through wiring harness 62. An inter-wire distance L1 represents the distance between wiring harness 61 and wiring harness 62.

In experiment system 60, an electromagnetic field is formed around each of wiring harnesses 61, 62 when an AC current is flowed through wiring harnesses 61, 62.

Stainless steel plate 63 is then exposed to the electromagnetic field radiated from each of wiring harnesses 61, 62. This causes magnetostriction in stainless steel plate 63, causing abnormal noise in stainless steel plate 63.

Herein, direction of current D1 of wiring harness 61 is opposite to direction of current D2 of wiring harness 62. The electromagnetic field formed around wiring harness 61 and the electromagnetic field formed around wiring harness 62 thus attenuate each other.

Thus, the degree of attenuation of an electromagnetic field can be measured by measuring a sound pressure of abnormal noise caused in stainless steel plate 63.

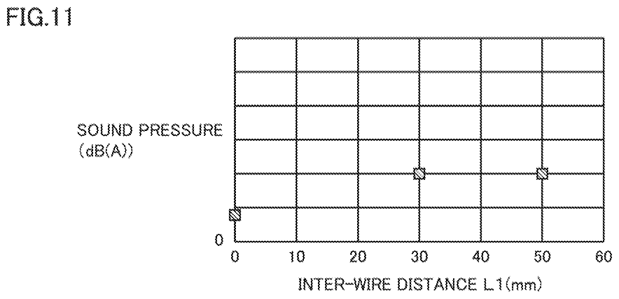

FIG. 11 is a graph showing results obtained in experiment system 60 by measuring sound pressures of sounds picked up by microphone 64 while variously changing inter-wire distance L1. The vertical axis represents a sound pressure measured by microphone 64, and the horizontal axis represents inter-wire distance L1.

Also as apparent from FIG. 11, it is revealed that electromagnetic fields counteract each other more as wiring harness 61 and wiring harness 62 are closer to each other. For example, it is revealed that the sound pressure decreases with inter-wire distance L1 smaller than 30 mm.

The present embodiment thus reveals that in terminal body 32 of movable terminal 22, an electromagnetic field is attenuated more as upright portions 42, 43 are closer to each other. For example, it is revealed that the distance between upright portion 42 and upright portion 43 be preferably equal to or smaller than 30 mm.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A relay device comprising:
a positive terminal;
a negative terminal spaced from the positive terminal; and
a movable terminal that moves between a connection position and a distant position, the connection position being a position at which the movable terminal connects the positive terminal to the negative terminal, the distant position being a position at which the movable terminal is distant from the positive terminal and the negative terminal, wherein
the movable terminal includes
a first contact portion connected to the positive terminal,
a first portion extending away from the first contact portion,
a second contact portion connected to the negative terminal,
a second portion extending away from the second contact portion, and
a connecting portion connecting the first portion to the second portion, and
the first portion and the second portion are disposed to be opposed to each other.

2. The relay device according to claim 1, wherein
the movable terminal includes
a first flange in which the first contact portion is formed, the first flange being formed to project from a first connecting portion at which the first flange is connected with the first portion, and
a second flange in which the second contact portion is formed, the second flange being formed to project from a second connecting portion at which the second flange is connected with the second portion, and
a length by which the first flange projects from the first connecting portion is smaller than each of a length of the first portion and a length of the second portion.

3. The relay device according to claim 1, wherein the positive terminal and the negative terminal are disposed to be opposed to each other.
